(19) United States
(12) Patent Application Publication
(10) Pub. No.: US 2006/0070244 A1
(43) Pub. Date: Apr. 6, 2006

(54) Disposable straight blade razor for consumers

(76) Inventor: Mel Lopez, New York, NY (US)

Correspondence Address: Steven Horowitz;Counselor At Law, Suite 700, 295 Madison Avenue, New York, NY, 10017, US

(21) Appl. No.: 11/285,857

(22) Filed: Nov. 23, 2005

Related U.S. Application Data
(63) Continuation-in-part of application No. 11/073,237, filed on Mar. 4, 2005.
Application No. 11/073,237 is a continuation-in-part of application No. 10/844,872, filed on May 12, 2004, now abandoned.

(51) Int. Cl. B26B 3/06; F41B 13/02

(52) U.S. Cl. 30/153; 30/155

(57) ABSTRACT

A straight blade razor allows consumers lacking professional dexterity put the blade against the skin at an ideal angle. A handle portion, a razor portion extending from the second segment of the handle portion including a detachable trapezoidal blade compartment for holding the blade which compartment includes a top, an end wall, left and right non-parallel side walls having a bottom end, and a smooth bottom wall having a gap between its first and second bottom wall segments through which the blade protrudes to a point slightly beyond the bottom wall but not as far as either bottom end of the side walls. The first and second bottom wall segments curve toward the top near the gap between them to encourage cut hair into the compartment. A planar retaining wall inside the blade compartment holds the blade at a fixed tilted angle relative to the skin.

### PRIORITY INFORMATION

This nonprovisional patent application is a continuation in part patent application of Applicant's pending U.S. patent application Ser. No. 11/073,237 entitled Disposable Straight Blade Razor for Consumers, filed Mar. 4, 2005, which pending application is incorporated by reference in its entirety and which pending application is itself a continuation in part patent application of U.S. patent application Ser. No. 10/844,872 filed May 12, 2004.

### FIELD OF THE INVENTION

The field of this invention is manual razors, and more particularly, straight blade razors that are disposable.

### BACKGROUND OF THE INVENTION AND DISCUSSION OF THE PRIOR ART

Professional straight blade razors, sometimes called “straight razors”, used by barbers for shaving a man's face have several advantages over the razors that are commonly purchased by consumers. One is that they can access hard to reach areas of the face and head. Examples of such hard to reach areas are the area behind the side burns, the areas behind the ears and the area under the nose. Another advantage is that the straight blade razors can make straighter edges thus permitting more precise and better grooming. In addition, in general they provide a cleaner shave. A further advantage that straight blade razors have over the T-shaped razor blades sold en masse to consumers is the attractive, old fashioned and slim look where the razor opens up to reveal a blade inside a compartment. Customers of barbers in fact often ask where they can get a professional looking razor since it has the old-fashioned and slim look. However, use of these razors requires skill to dexterously hold them at the proper angle against the skin. If the blade is not properly tilted the blade and is then held perpendicular to the skin, it will cause cuts on the face, neck and other parts of the skin. Due to the danger of such cuts, those consumers that are not trained in their use cannot realistically avail themselves of the advantages of this razor. Instead, they commonly use the T-shaped razor blade. Another reason such cuts are disfavored is the fear of serious diseases such as hepatitis and AIDS that are passed through blood

Therefore there is a need for a shaving device that allows consumers to avail themselves of the advantages of a straight blade razor without the safety dangers present for the average consumers who is not specifically trained in the handling and use of a professional straight blade razor. There have been other designs of the prior art that attempt to accomplish this objective. However, they typically involve designs that are more complicated than that of the present invention, which involves a single blade inside a simply constructed straight razor.

### SUMMARY OF THE PRESENT INVENTION

A straight blade razor that allows consumers to have the advantages of the professional straight razor blade without the safety dangers associated therewith. The straight blade razor of the present invention comprises a handle portion having a first and second segment, the end of a first segment of the handle portion having a screw or other attachment means at a pivot point upon which the second segment pivots so that the first and second segments pivot with respect to one another. The razor also includes a razor portion including a blade compartment for holding the blade inside the compartment tilted so that it is no longer perpendicular to the facial skin. The consumer need not figure out which angle is the correct angle to hold the razor at since the razor is simply held so that the open compartment side through which the blade extends is flush against. The blade is positioned in the cavity defined by the blade compartment at a tilt whose angle represents the proper angle for the blade to be held against the skin when the blade compartment's edges are flush against the skin.

The blade compartment defines a cavity for holding the blade, said blade compartment having a trapezoidal cross section and including a top, an end wall, left and right side walls that are not parallel to one another, each side wall having a bottom end, and including a bottom wall having a first bottom wall segment and a second bottom wall segment and a gap between the first and second bottom wall segments through which the blade protrudes to a point slightly beyond the bottom wall but not as far as either bottom end of the side walls, the first and second bottom wall segments near the gap curving toward the top, the blade compartment narrower at the bottom wall than at the top, the bottom wall being smooth and regular so as to make contact with the surface during use, the left side wall and the right side wall meeting the bottom wall at a substantially equidistant distance from the bottom ends of the left and right side walls, said distance being small relative to a length of the side walls. A planar retaining wall inside the blade compartment holds the blade in the cavity in fixed position, the blade positioned in the cavity at a tilt so that when the bottom wall and the bottom ends of the left and right side walls are held flush against the surface the blade is at a fixed angle to said surface, said fixed angle being between approximately 30 degrees and approximately 60 degrees.

In a preferred embodiment, the planar retaining wall has a first retaining wall segment and a second retaining wall segment, an end of the first retaining wall segment traversing the at least one aperture of the blade and the second retaining wall segment attaching to the end of the first segment. In a preferred embodiment, the distance between the bottom ends is between approximately 4.5 and approximately 6 millimeters.

Apertures on each side wall of the blade compartment allow the user to quickly rinse out the hair that has accumulated so far during the shave and to immediately resume the shaving process without delay and without a clogging problem. The entire blade compartment including the blade inside it snaps off the remainder of the device and is disposable.

### IMPORTANT OBJECTS AND ADVANTAGES

The following important objects and advantages of the present invention are:
(1) to provide a manual straight blade razor that has none of the traditional disadvantages associated with straight blade razors;
(2) to provide a manual straight blade razor that is appropriate for use by consumers;
(3) to provide a manual straight blade razor that can be used safely by individuals who are not professional and who are not trained in the use of professional razor blades;
(4) to provide a manual straight blade razor that does not require manual dexterity with respect to maintenance of said razor at the proper angle relative to the user's skin;
(5) to provide a manual straight blade razor that has the sleek and trim look of a professional razor blade;
(6) to provide a manual straight blade razor that has the structure of a professional straight razor, including the facile handle of a professional straight razor;
(7) to provide a manual straight blade razor that has a means for the user to wash off the razor hair that has accumulated from the shave to avoid clogging;
(8) to provide a manual straight blade razor that provides a faster shave since quick rinsing off of accumulated hairs is possible due to special apertures in the blade compartment or head of the razor;
(9) to provide a manual straight blade razor that does not get clogged during use;
(10) to provide a manual straight blade razor whose blade is positioned so that there is only manner of holding the blade in relation to the user's skin;
(11) to provide a manual straight blade razor that has a blade whose angled tilt is fixed in place permanently;
(12) to provide a straight blade razor that does not require the extraordinary care during use that is typically required with a professional straight blade razor;
(13) to provide a straight blade razor with the above advantages that also has the advantage of being of very simple construction;
(14) to provide a straight blade razor that avoids the need for constant sterilization of a blade before re-use since it has a disposable blade compartment;
(15) to provide a straight blade razor that is structured so as to encourage cut hair to enter the blade compartment;
(16) to provide a straight blade razor that at its narrower side forms a pocket bordered by the skin surface for the cut hair to held in until it enters the blade compartment;
(17) to provide a straight blade razor having a blade compartment having a trapezoidal cross-section;
(18) to provide a straight blade razor whose blade compartment's narrower side is narrow enough to give a close shave in hard to reach corners of the face yet wide enough to allow a non-dexterous layman to place the compartment against the skin and shave with a blade at the fixed angle that professionals prefer to use.

### BRIEF DESCRIPTION OF THE DRAWINGS

FIG. 1 is a perspective view of the professional straight blade razor of the present invention;

FIG. 2 is a fragmentary perspective view showing the inside of the blade compartment of the straight blade razor of the present invention;

FIG. 3 is a cross-sectional view of a blade and blade compartment of the straight blade razor of the present invention in shaving position;

FIG. 3A is a top plan view of the blade of the present invention

FIG. 4 is a top plan view of the blade compartment of the razor of the present invention broken away and showing the marking line; and

FIG. 5 is a cross-sectional view of a blade and blade compartment of the straight blade razor of the present invention showing a male member projecting from the end of the first retaining wall segment through an aperture within the blade and into a female member on an end of the second retaining wall segment.

### DETAILED DESCRIPTION OF THE PREFERRED EMBODIMENT

The apparatus of the present invention will now be illustrated by reference to the accompanying drawings. The straight blade razor of the present invention has been assigned reference numeral 10. Other elements have been assigned the reference numerals referred to below.

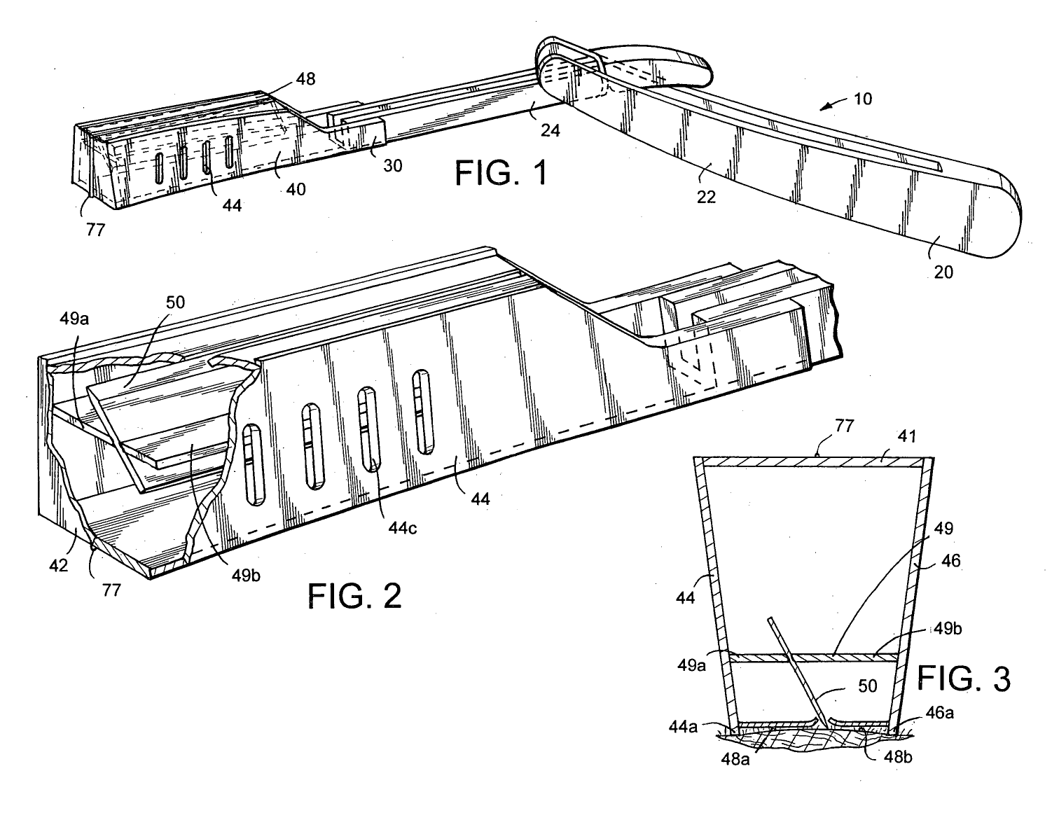

As seen from FIGS. 1-3, straight blade razor 10 allows consumers to have the advantages of the professional straight razor blade without the safety dangers associated therewith. The straight blade razor of the present invention comprises a handle portion 20 having a first segment 22 and second segment 24, the end of a first segment 22 of the handle portion 20 having a screw or other attachment means at a pivot point upon which the second segment 24 pivots so that the first segment 22 and the second segment 24 pivot with respect to one another.

The razor also includes a razor portion 30 including a blade compartment 40, that is, the razor portion extends from the second segment 24 of the handle portion and includes a detachable and disposable blade compartment 40. The razor includes a blade 50. The blade 50 has at least one aperture therein to assist in being fixed in place. In a preferred embodiment, blade 50 includes a series of apertures that are co-linear. In one preferred embodiment, there are approximately four separate apertures in blade 50.

In certain embodiments, the entire razor 10 (other than blade 50), not just blade department 40, can be made out of plastic and be disposable.

Blade compartment 40 defines a cavity for holding the blade 50, as best seen from FIGS. 1-2 said blade compartment having a trapezoidal cross section with the blade compartment 40 narrower at the bottom wall 48 than at the top 41. This adds to the stability of blade compartment 40 because it makes it easier for the manufacturer of the device of the present invention to fit the blade 50 into blade compartment 40.

Blade compartment 40 includes a top 41, an end wall 42, left side wall 44, a right side wall 46, the left and right side walls 44, 46 not being parallel to one another. Each side wall 44, 46 having a bottom end 44a, 46a. Blade compartment 40 also includes bottom wall 48 comprised of first bottom wall segment 48a and second bottom wall segment 48b and a gap between the first and second bottom wall segments 48a, 48b.

Although in a preferred embodiment blade compartment 40 includes end wall 42, in a less preferred alternative embodiment end wall 42 is not present.

Although the present invention is not limited to any particular size, unless specified below, or to any particular angle between the side walls 44, 46 and the top 41 and bottom wall 48, in one preferred embodiment, the distance from bottom wall 48 to the top 41 approximately 10 to approximately 15 millimeters and the width of top 41 is approximately 8 to approximately 10 millimeters. The distance from one bottom end 44a to a second bottom end 46a of side walls 44, 46 is approximately 4.5 to approximately 6 millimeters in a preferred embodiment.

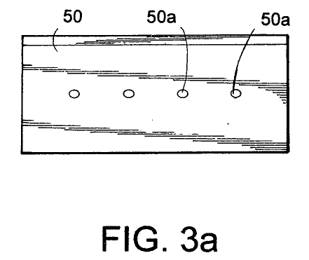

As best seen from FIG. 3, blade 50 protrudes through the gap in bottom wall 48 to a point slightly beyond the bottom wall but not as far as either bottom end 44a, 46a, of the side walls 44, 46. In addition, the part of first and second bottom wall segments 48a, 48b near the gap in bottom wall 48 curve toward the top 41. This permits hair being cut to enter blade compartment 40 thereby making it easier to cut said hair.

As stated, blade 50 projects beyond bottom wall 48 only slightly and not quite as far as the tips of bottom ends 44a, 46a of side walls 44, 46. This is so hair on the surface of the skin being shaved is placed initially in a pocket bounded by the bottom wall, the skin surface and the bottom end portions of left and side walls 44, 46, said bottom end portions of left and right side walls being defined as the portions of these side walls running from the bottom ends to the part of the side wall that meets bottom wall 48. The razed hair then is expected to leave the pocket and enter blade compartment 40, where it can washed off. As shown in FIGS. 1-2, a series of apertures in side walls 44, 46 of blade compartment 40 allow easy rinsing of hair out of blade compartment 40.

As seen from FIG. 3, moreover, bottom ends 44a, 46a of the pocket slightly pinch the skin surface so that this surface being shaved curves somewhat toward blade 50 and is most curved at a point substantially median between the bottom end portions 44a, 46a of the left and right side walls 44, 46.

Bottom wall 48 is also smooth and regular so as to make contact with the surface during use, the left side wall 48a and the right side wall 48b meeting the bottom wall at a substantially equidistant distance from the bottom ends of the left and right side walls, that distance being very small and certain small relative to a length of the side walls.

In order to hold blade 50 in the cavity defined by the blade compartment 40 in a fixed position, blade compartment 40 has within it a planar retaining wall 49 inside the blade compartment 40, the blade positioned in the cavity at a tilt so that when the bottom wall and the bottom ends of the left and right side walls are held flush against the surface the blade is at a fixed angle to said surface, said fixed angle being between approximately 30 degrees and approximately 60 degrees.

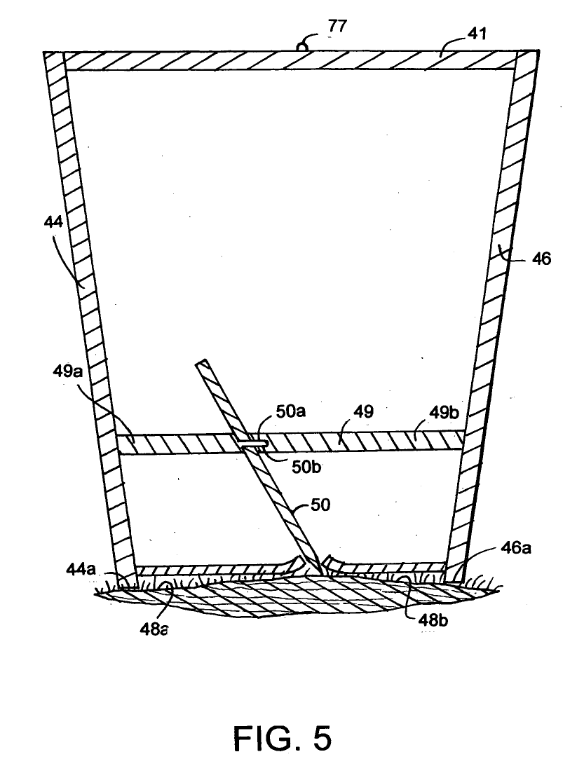

In a preferred embodiment, the planar retaining wall 49 has a first retaining wall segment 49a and a second retaining wall segment 49b, each retaining wall segment 49a, 49b having ends that complement one another. For example, in a preferred embodiment, an end of the first segment traverses the at least one aperture of the blade 50 and the second segment attaches to the end of the first segment. In one version, one or more nipples 50a or male members 50a projecting from the end of the first retaining wall segment 49a extends non-reversibly through one aperture of the at least one aperture within blade 50 and this end attaches to a female member on the end of the second retaining wall segment 49b. Although FIG. 5 shows a cross-sectional view revealing one particular male member 50a projecting from the end of the first retaining wall segment 49a through an aperture within the blade 50 into a female member 50b on an end of the second retaining wall segment 49b, other hypothetical cross-sectional cuts at other suitable points crossing first retaining wall segment 49a, blade 50 and second retaining wall segment 49b would also look like FIG. 5 and have the same property of non-reversability.

The present invention contemplates any other suitable and effective means of attaching the end of one retaining wall segment to the end of the second retaining wall segment whereby one of the ends extends through the at least one aperture of blade 50 to hold it in place. In a preferred embodiment planar retaining wall 49 is substantially parallel to the top 41 and bottom 48. However, the present invention contemplates other configurations for planar retail wall 49.

As best seen from FIG. 3, the bottom ends of left and right side walls are aligned so as to simultaneously make contact with a shaver's skin together with bottom wall when the straight blade razor 10 is in use.

The blade 50 is positioned in the cavity defined by the blade compartment 40 at a tilt whose angle represents the proper angle for the blade 50 to be held against the skin when the blade compartment's bottom wall and bottom ends 44a, 46a are flush against the skin 60 during use of the straight blade razor 10.

Preferably, blade compartment 40 is somewhat wider than a typically blade compartment of a typical professional straight blade razor. Thus blade 50 is positioned in the cavity at a tilt so that when the blade compartment 40 is held flush to the surface, blade 50 is at a fixed angle to said surface.

It has been found that the blade of a professional straight blade razor should be maintained at a fixed angle to the surface of the skin but this fixed angle can range from between approximately 20 degrees and approximately 70 degrees. However, in a preferred embodiment, the fixed angle should be between approximately 30 degrees and approximately 60 degrees. Furthermore, in a more preferred embodiment, the fixed angle should be between approximately 40 degrees and approximately 50 degrees and ideally approximately 45 degrees in order to avoid cutting the skin. Thus the most preferred angle between the blade 50 and the area of the skin 60 between shaved by the blade 50 of the professional straight blade razor 10 is between approximately 40 and approximately 50 degrees.

It should be noted that although FIG. 3 depicts blade 50 in a way that appears to suggest that blade 50 is not at a 45 degree angle to the skin 60, this is not the intent of this figure. Blade 50 is maintained in its tilted position by any of various suitable means. One such means is a simple blade holder. The blade holder itself can be tilted or the opening in the blade holder for insertion of the blade can be angled. Blade 50 extends at least slightly through a bottom of the cavity. Preferably, blade 50 extends only slightly through said cavity.

It has been found that the width of the blade compartment 40 at the narrower wall of the trapezoidal cross-section of blade compartment 40, which is best defined as the distance between bottom ends 44a, 46a of side walls 44, 46 is ideally between approximately 4 and one half millimeters and approximately 6 millimeters. Alternatively, this can be defined as the length of bottom wall 48 including the gap and the thickness of side walls 44, 46. This is small enough to provide a close shave and yet large enough to achieve the purpose of the invention, namely allow a non-professional to place blade compartment 40 against the skin in a stable manner and hence determine the angle of blade 50 to the skin without having to figure out what that angle should be.

Since bottom ends 44a, 46a of side walls 44, 46 are useful in conjunction with bottom wall 48 as reference points for holding the blade compartment 40 flush against the skin 60 being shaved, bottom ends 44a, 46a are aligned with one another so as to simultaneously make contact with the surface being shaved—that is they are equidistant from bottom wall 48. Bottom wall 48 must be substantially smooth and regular other than the fact that a blade protrudes through it slightly.

Bottom wall 48 can be described as incomplete because it has a gap to allow for the protrusion of blade 50, thereby allowing the non-professional user to easily align the razor 10 against the skin 60 being shaved without having to dexterously figure out what angle to have the blade 50 meet the skin 60.

Since the blade compartment 40 that houses the blade 50 is wider than normal and the blade inside the compartment is tilted so that it is no longer perpendicular to the facial skin, the consumer need not figure out which angle is the correct angle to hold the razor at since the razor is simply held so that the open compartment side through which the blade extends is flush against the skin.

Apertures on each side wall 44, 46 of the blade compartment, for example 44c, allow the user to quickly rinse out the hair that has accumulated so far during the shave and to immediately resume the shaving process without delay and without a clogging problem.

The entire razor portion 30 including blade compartment 40 having blade 50 inside said compartment 40 detaches in one motion, such as by snapping off, from handle portion 20 and hence from the remainder of the straight blade razor 10. Thus razor portion 30 is disposable. In keeping with its disposability feature, razor portion 30 is made entirely of plastic or another suitable rigid mass-producible and inexpensive material with the exception of the blade 50 itself.

Typical professional straight blade razors of the prior art has a movable metal cartridge in the blade compartment which cartridge includes a portion thereof that functions as the blade holder. The razor 10 of the present invention does not require this cartridge and only requires planar retainer wall 49 to hold the blade inside the blade compartment 40. Alternatively, a simple blade holder in the form of a clip that has a frictional fit for maintaining the blade 50 in position or to which the blade 50 is rigidly affixed. The clip or other attachment means for holding blade 50 would typically project from an inside ceiling of the blade compartment 40 opposite top 41. This attachment means could even be adhesive if the adhesive were strong, reliable and durable enough. Alternatively, instead of a blade holder, the blade 50 could be inserted and affixed into an indentation or hole on the inside ceiling or top 42 of blade compartment 40 and held there through any of various means that are well known in the art.

Razor 10 of the present invention is of simple construction and other than the tilted blade and the wider blade compartment involves no new parts or materials. Thus the plastic razor portion 30 would come with the blade already affixedly inserted into the razor portion 30 for use.

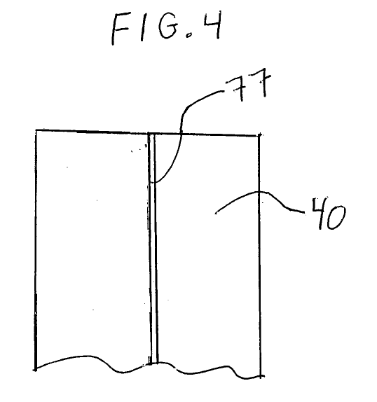

In accordance with the present invention, as best seen in FIGS. 1-25, an additional optional feature is that top 41 of the blade compartment 40 has drawn thereon a line 77 that simulates the location of the edge of the blade 50 that is in contact with the skin. Although due to the unique configuration of blade 50 within blade compartment 40 in accordance with the present invention one can shave by holding bottom ends 44a, 46a and preferably bottom wall 48 line 77 is also available to tell a user who is shaving while looking in the mirror the location (not the angle) of the blade 50 within blade compartment 40. Line 77 can also extends to the end wall wall 42 of closed blade compartment 40 and is aligned with, the position of the far edge of the blade 50. This allows the user to imagine the location of the blade 50 inside blade compartment 40 during use, although this is not necessary to use the razor 10 of the present invention. Although line 77 can be printed thereon, in a preferred embodiment, line 77 has three dimensional shape and may be placed thereon by any well known means such as spraying, embossing, printed or simply including it in the shape of the plastic blade compartment 50.

Viewing FIG. 3, the direction of the motion of the blade compartment 40 along the skin surface 60 is left to right.

The phrase “narrower side of the blade compartment” or its equivalent as used herein refers to the area bounded by the bottom ends of the side walls, whereas the top 41 is the wider side of the trapezoidal blade compartment 40.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A manual straight blade razor for shaving a surface of a skin of a user, comprising:
a handle portion,
a razor portion extending from the handle portion, the razor portion including a blade compartment,
a blade,
the blade compartment defining a cavity for holding the blade, said blade compartment including a top, left and right side walls, each side wall having a bottom end, and including a bottom wall having a first bottom wall segment and a second bottom wall segment and a gap between the first and second bottom wall segments through which the blade protrudes to a point beyond the bottom wall, the bottom wall being smooth so as to make contact with the surface during use,
a planar retaining wall inside the blade compartment for holding the blade in the cavity in a fixed position, the blade positioned in the cavity at a tilt so that when the bottom wall and the bottom ends of the left and right side walls are held flush against the surface the blade is at a fixed angle to said surface, said fixed angle being between approximately 30 degrees and approximately 60 degrees.

2. The straight blade razor of claim 1, wherein the handle portion has a first segment and a second segment, the first and second segment in a pivoting relation to one another, wherein the razor portion extends from the second segment of the handle portion and wherein the blade compartment has an end wall.

3. The straight blade razor of claim 1, wherein the blade has at least one aperture and wherein the planar retaining wall has a first retaining wall segment and a second retaining wall segment, an end of the first retaining wall segment traversing the at least one aperture of the blade and the second retaining wall segment attaching to the end of the first segment.

4. The straight blade razor of claim 3, wherein the planar retaining wall is substantially parallel to the top.

5. The straight blade razor of claim 3, wherein the fixed angle is between approximately 40 degrees and approximately 50 degrees.

6. The straight blade razor of claim 5, wherein the fixed angle is approximately 45 degrees.

7. The straight blade razor of claim 3, wherein the blade compartment has a series of apertures on each side wall of the blade compartment to allow rinsing hair from the blade compartment.

8. The straight blade razor of claim 3, wherein the top of the blade compartment has a marking line that is aligned with a far edge of the blade to allow the user to imagine a location of the blade.

9. The straight blade razor of claim 8, wherein the marking line also extends across the end wall.

10. The straight blade razor of claim 3, wherein the distance from the bottom end of the left side wall to the bottom end of the right side wall is between approximately 4 and one half millimeters to approximately 6 millimeters.

11. The straight blade razor of claim 2, wherein the blade compartment has a trapezoidal cross section, includes left and right side walls that are not parallel to one another and is narrower at the bottom wall than at the top.

12. The straight blade razor of claim 2, wherein the blade protrudes to a point slightly beyond the bottom wall but not as far as either bottom end of the side walls.

13. The straight blade razor of claim 2, wherein the first and second bottom wall segments near the gap curve toward the top.

14. The straight blade razor of claim 2, wherein the blade compartment has a trapezoidal cross section, includes left and right side walls that are not parallel to one another and is narrower at the bottom wall than at the top, and wherein the blade protrudes to a point slightly beyond the bottom wall but not as far as either bottom end of the side walls.

15. The straight blade razor of claim 2, wherein the blade protrudes to a point slightly beyond the bottom wall but not as far as either bottom end of the side walls, and wherein the first and second bottom wall segments near the gap curve toward the top.

16. The straight blade razor of claim 2, wherein the blade compartment has a trapezoidal cross section, includes left and right side walls that are not parallel to one another and is narrower at the bottom wall than at the top, and wherein the first and second bottom wall segments near the gap curve toward the top.

17. The straight blade razor of claim 2, wherein the blade compartment has a trapezoidal cross section, includes left and right side walls that are not parallel to one another and is narrower at the bottom wall than at the top, wherein the blade protrudes to a point slightly beyond the bottom wall but not as far as either bottom end of the side walls, and wherein the first and second bottom wall segments near the gap curve toward the top.

18. The straight blade razor of claim 2, wherein the blade compartment is detachable and disposable.

19. The straight blade razor of claim 2, wherein the left side wall and the right side wall meet the bottom wall at a substantially equidistant distance from the bottom ends of the left and right side walls, said distance being small relative to a length of the side walls.
